(19) United States
(12) Patent Application Publication
(10) Pub. No.: US 2010/0306980 A1
(43) Pub. Date: Dec. 9, 2010

(54) Clutching Jig

(76) Inventors: Yi-Chang Yang, Taipei (TW); Kuo-Chuan Chiu, Taipei (TW); Feng-Chi Lee, Taipei (TW); Chin-Chou Wang, Taipei (TW)

Correspondence Address: LIN & ASSOCIATES INTELLECTUAL PROPERTY, INC., P.O. BOX 2339, SARATOGA, CA, 95070-0339, US

(21) Appl. No.: 12/480,029

(22) Filed: Jun. 8, 2009

(51) Int. Cl. B25B 27/02

(52) U.S. Cl. 29/278; 29/270; 29/283

(57) ABSTRACT

A clutching jig used to disassemble a lens module which includes a lens socket and a lens component mounted to the lens socket by a plurality of buckling pieces of the lens socket abutting to the lens component has a rectangular base. The base defines two opposite lateral surfaces, a bottom surface and a slot passing through the bottom surface and the two opposite lateral surfaces to divide the base into a first holding portion and a second holding portion. The bottom surface has a receiving recess at a center portion thereof for communicating with the slot. The receiving recess receives the lens component, with a circumferential dimension thereof lessened to clutch the lens component when the first holding portion and the second holding portion are urged to approach each other.

### BACKGROUND OF THE INVENTION

1. Field of the Invention

The invention relates to a clutching jig, and more particularly to a clutching jig for conveniently disengaging a lens component from a lens socket.

2. The Related Art

As the digital products have been diversely developed, such as personal digital assistants (PDA), mobile phones, or other small portable terminal apparatuses, each of them is broadly combined with a miniature photographing device, like lens module, to perform the photographing function. The lens module includes a lens socket and a lens component provided the lens socket. In the process of assembly and repair, the users usually need to clutch the lens component out of the lens socket.

Please refer to FIG. 4, a traditional disengaged jig 400 includes a housing 1 having a square shape. A square hole 2 is formed in the middle of the housing 1. A Plywood 102 and three pressure plates 101 are protruded downwards from each side of the housing 1, and the pressure plates 101 being against the plywood 102. A lens module includes a lens component 200 and a lens socket 300 for receiving the lens component 200. A groove 202 is formed in each corner of a base of the lens component 200. A notch 302 is formed in each of inner sides of the lens socket 300. A buckling piece 301 is located in the notch 302 with a free end thereof buckled in the groove 202, so the lens component 200 is buckled firmly in the lens socket 300. The size of the lens socket 300 perfectly matches with the disengaged jig 400.

While the disengaged jig 400 is inserted into the lens socket 300, the buckling pieces 301 are pressed and pushed back into the notches 302 by the pressure plates 101, so the lens component 200 is not fastened by the buckling pieces 301. Then, the lens component 200 can be disengaged from the lens socket 300 by other jig device.

As described above, the disengaged jig 400 just releases the lens component 200 from the fastening of the buckling pieces 301 and is difficult to take out the lens component 200 from the lens socket 300 by itself.

### SUMMARY OF THE INVENTION

An object of the present invention is to provide a clutching jig with a simple structure capable of disengaging a lens component from a lens socket easily.

A clutching jig used to disassemble a lens module which includes a lens socket and a lens component mounted to the lens socket by a plurality of buckling pieces of the lens socket abutting to the lens component has a substantially rectangular base. The base defines two opposite lateral surfaces, a bottom surface and a slot passing through the two opposite lateral surfaces and the bottom surface to divide the base into a first holding portion and a second holding portion. The bottom surface has a receiving recess at a center portion thereof for communicating with the slot. The receiving recess receives the lens component, with a circumferential dimension thereof lessened to clutch the lens component when the first holding portion and the second holding portion are urged to approach each other.

As described above, the clutching jig is provided with the slot to disengage the first holding portion and the second holding portion, which are urged to approach each other for holding the lens component. Therefore, the clutching jig is able to clutch the lens component out of the lens socket easily, without using other jig device. Furthermore, the structure of the clutching jig will be simple and compact, which can shorten the manufacturing time and lower the cost, fit for wider applications.

### BRIEF DESCRIPTION OF THE DRAWINGS

The present invention will be apparent to those skilled in the art by reading the following description thereof, with reference to the attached drawings, in which:

FIG. 1 is a perspective view of a clutching jig of an embodiment according to the present invention;

FIG. 2 is a perspective view of the clutching jig shown in FIG. 1 seen from another direction;

FIG. 3 is a perspective view of the clutching jig shown in FIG. 1, wherein a lens module is provided; and

FIG. 4 is a perspective view of a disengaged jig in prior art, wherein a lens module is provided.

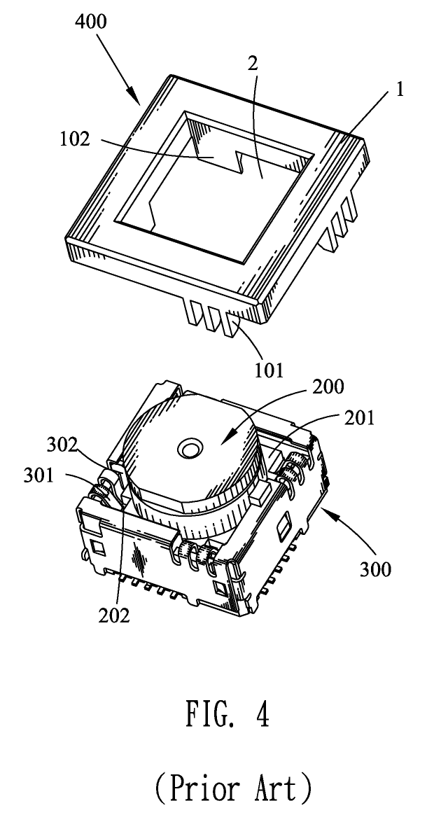

### DETAILED DESCRIPTION OF THE PREFERRED EMBODIMENT

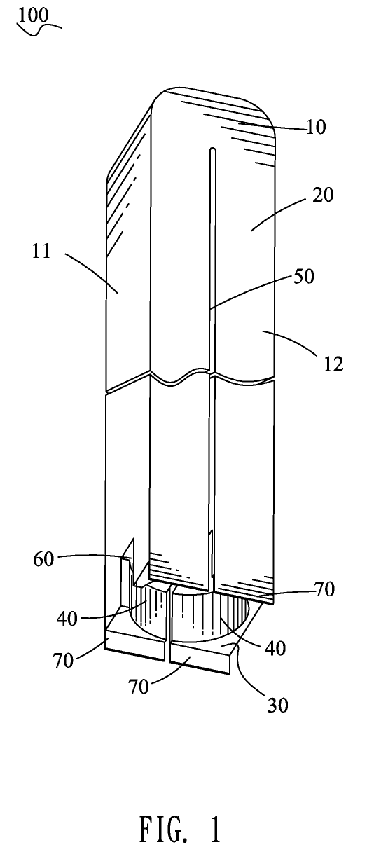

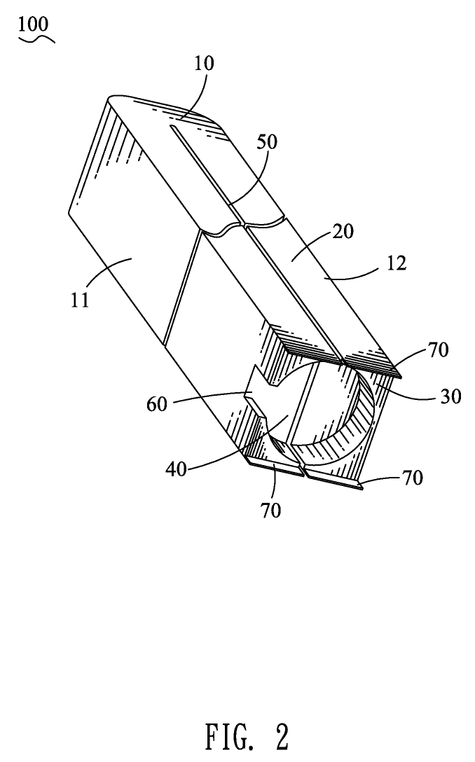

Please refer to FIG. 1 and FIG. 2, a clutching jig 100 according to the present invention includes a rectangular base 10. The base 10 defines two opposite lateral surfaces 20 and a bottom surface 30, and has a slot 50 at a middle portion of the lateral surface 20 along an up and down direction. The slot 50 passes through the whole base 10 along a direction perpendicular to the lateral surfaces 20 and reaches the bottom surface 30 to divide the base 10 into a first holding portion 11 and a second holding portion 12. The lateral surfaces 20 are respectively extended downwards a distance to form an inserting slice 70. Herein, the inserting slices 70 are divided into two parts by the slot 50. The bottom surface 30 is formed with a circular receiving recess 40 at a middle portion thereof, communicating with the slot 50. A sidewall of the receiving recess 40 defines a fool-proof gap 60 which has a substantially equal distance from the two opposite lateral surfaces 20.

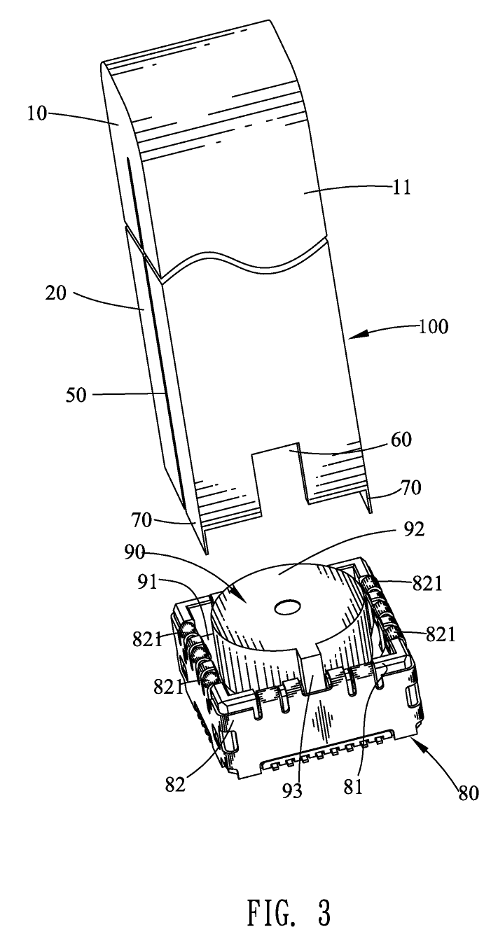

Please refer to FIG. 3, a lens module includes a lens socket 80 and a lens component 90 disposed into the lens socket 80. The lens component 90 has a lens base 91 and a round lens body 92 located on the lens base 91. The lens body 92 has a fool-poof projection 93 protruded outwards from a side thereof. The lens socket 80 has an insulating housing 81 and a metal shell 82 enclosing the insulating housing 81. The metal shell 82 has a plurality of buckling pieces 821 which project inwards to abut against a top and sidewalls of the lens base 91 for fastening the lens component 90 in the lens socket 80 firmly after the lens component 90 is inserted into the lens socket 80.

Please refer to FIG. 3 again, when the clutching jig 100 is used to disengage the lens component 90 from the lens socket 80, the clutching jig 100 is firstly adjusted and positioned by the fool-proof projection 93 inserted into the fool-proof gap 60. The lens body 92 is received in the receiving recess 40. The bottom surface 30 of the clutching jig 100 faces and rely on the top of the lens base 91, so that the bucking pieces 821 are urged to be apart from the lens component 90. The inserting slices 70 are inserted between the lens socket 80 and the lens component 90 and press the buckling pieces 821 against the sidewalls of the body 91. Thus the lens component 90 is disengaged from the bulking pieces 821. At this time, the first and the second holding portions 11, 12 are gripped to approach each other to clutch the lens component 90, and pulled upwardly with the lens component 90, releasing the lens component 90 from the lens socket 80.

As describe above, the clutching jig 100 is provided with the slot 50 to disengage the first holding portion 11 and the second holding portion 12, which are urged to approach each other for holding the lens component 90. Therefore, the clutching jig 100 is able to clutch the lens component 90 out of the lens socket 80 easily, without using other jig device any more. Furthermore, the structure of the clutching jig 100 will be simple and compact, which can shorten the manufacturing time and lower the cost, fit for wider applications.

Furthermore, the present invention is not limited to the embodiment described above; various additions, alterations and the like may be made within the scope of the present invention by a person skilled in the art. For example, respective embodiments may be appropriately combined.

What is claimed is:

1. A clutching jig used to disassemble a lens module which includes a lens socket and a lens component mounted to the lens socket by a plurality of buckling pieces of the lens socket abutting to the lens component, comprising:
a substantially rectangular base, the base defining two opposite lateral surfaces, a bottom surface, and a slot passing through the opposite lateral surfaces and the bottom surface to divide the base into a first holding portion and a second holding portion, the bottom surface having a receiving recess at a center portion thereof for communicating with the slot, the receiving recess receiving the lens component, with a circumferential dimension thereof lessened to clutch the lens component when the first holding portion and the second holding portion are urged to approach each other.

2. The clutching jig as claimed in claim 1, wherein the opposite lateral surfaces are extended downwards to form two inserting slices for inserting between the lens socket and the lens component.

3. The clutching jig as claimed in claim 1, wherein a sidewall of the receiving recess defines a fool-proof gap which has a substantially equal distance from the two opposite lateral surfaces.
